(19) United States
(12) Patent Application Publication
(10) Pub. No.: US 2005/0270705 A1
(43) Pub. Date: Dec. 8, 2005

(54) Magneto-resistive element, thin film magnetic head, magnetic head and magnetic recording/reproducing apparatus

(75) Inventors: Yoshihiro Tsuchiya, Tokyo (JP); Koji Shimazawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK Corporation, Tokyo (JP)

(21) Appl. No.: 11/141,313

(22) Filed: Jun. 1, 2005

(30) Foreign Application Priority Data
Jun. 2, 2004 (JP) 2004-165080

(51) Int. Cl. G11B 5/33; G11B 5/127

(52) U.S. Cl. 360/324.11

(57) ABSTRACT

In a structure in which an anti-ferromagnetic layer, a first ferromagnetic layer, a non-magnetic layer and a free layer are sequentially adjacent to each other, the first ferromagnetic layer is set so that a saturation magnetostriction is not greater than (+3)×10⁻⁵ and an exchange coupling magnetic field Hex between itself and the anti-ferromagnetic layer is not less than 48 (kA/m).

### BACKGROUND OF THE INVENTION

1. Field of the Invention

The present invention relates to a magneto-resistive element, a thin film magnetic head, a magnetic head apparatus and a magnetic recording/reproducing apparatus, and more particularly to an improvement in a dual spin valve film having a synthetic pinned layer.

2. Description of the Related Art

A magneto-resistive element (which will be referred to as an MR element hereinafter) is used for a magnetic storage element, a magnetic sensor, a thin film magnetic hear or the like. As the MR element, there is known a giant magneto-resistive element (which will be referred to as a GMR element hereinafter) using a magnetic tunneling magneto-resistive film (which will be referred to as a TMR film hereinafter), a spin valve film (which will be referred to as an SV film hereinafter) or the like. A main application of the MR element is a thin film magnetic head, and the thin film magnetic head using an SV film forms a current main stream on a practical level of the MR element.

As well known from Patent Reference 1 (Japanese Patent Application Laid-open No. 1996-21166), Patent Reference 2 (Japanese Patent Application Laid-open No. 1994-236527) or the like, the thin film magnetic head using the SV film includes a free layer, a non-magnetic electroconductive layer, a magnetization secured layer (a pinned layer) and an anti-ferromagnetic layer. Characteristics of the head such as an output are determined by an angle formed by a magnetization direction of the pinned layer and a magnetization direction of the free layer which are partitioned by a thin film of the non-magnetic electroconductive layer. The magnetization direction of the free layer can be readily directed to a direction of a magnetic field from a medium. The pinned layer is exchange-coupled with the anti-ferromagnetic layer, and the magnetization direction of the pinned layer is controlled in one direction (a pinned direction). Since the intensity of an exchange coupling force and the thermal stability greatly affect the characteristics or the reliability of the head, it is demanded to generate an exchange coupling force as large as possible. Based on this demand, there is proposed use of an IrMn alloy, an NiMn alloy and a PtMn alloy which are anti-ferromagnetic layer materials with which very intensive exchange coupling can be achieved.

In the thin film magnetic head described in Patent Reference 1 and Patent Reference 2, when a film thickness of the free layer is reduced for the purpose of improving the sensitivity which is essential for narrowing a recording track width to realize a high density, a leakage magnetic filed from the pinned layer involves shifting of an operating point, and it is difficult to accurately correct this shift quantity by using a current magnetic field.

As one of means for solving the above-described problem, Patent Reference 3 (Japanese Patent Application Laid-open No. 2000-137906) discloses a technique which changes a pinned layer structure which is in contact with an anti-ferromagnetic layer from a conventional single-film structure to a three-layer structure of a first ferromagnetic layer/a coupling film/a second ferromagnetic layer (which will be referred to as a synthetic pinned layer) so that intensive exchange coupling can be provided between the two ferromagnetic layers, thereby effectively increasing the exchange coupling force from the anti-ferromagnetic layer. In this synthetic pinned layer, all of the leakage magnetic field can be reduced to zero in principle, thereby readily assuring an operating point.

Further, Patent Reference 4 (Japanese Patent Application Laid-open No. 2002-185060) discloses a dual type element in which synthetic pinned layers are arranged in the vertical direction with a free layer sandwiched therebetween in order to increase an MR ratio. In this case, as to the upper synthetic pinned layer and the lower synthetic pinned layer, magnetization directions of the pinned layers which are in contact with the free layer must face the same direction.

However, in case of the single-film structure and the synthetic pinned layer, although the magnetization direction of the pinned layer is in a predetermined direction in a characteristic measurement on a wafer, magnetization reversal may be generated in the pinned layer in some cases when a product is cut from the wafer and manufactured into an individual body through polishing.

When magnetization reversal occurs in the pinned layer, a relative relationship with a sense current is reversed from an expected relationship, and hence predetermined electrical/magnetic characteristics cannot be obtained.

The magnetization reversal phenomenon in the pinned layer results in a further serious situation in the dual type element. In a dual SV film type magnetic head, a pinned layer which is in contact with a free layer in the upper synthetic pinned layer and a pinned layer which is in contact with the free layer in the lower synthetic pinned layer must have the same magnetization direction.

However, a stress in a polishing process or an actual use state is further intensively applied to the upper synthetic pinned layer as compared with the lower synthetic pinned layer because of the structure, and hence there may occur a problem that a direction of an exchange coupling magnetic field varies in the upper synthetic pinned layer and magnetization of the pinned layer is reversed. Therefore, although a predetermined MR ratio is obtained in the characteristic measurement on the wafer, there may occur a problem that the MR ratio is extremely lowered and a reproduction output cannot be hardly obtained when a product is cut from the wafer and manufactured into an individual body through polishing or in an actual use condition. The extreme reduction in MR ratio and reproduction output not only causes a large reduction in yield ratio but also considerably decreases the reliability. The prior art references described above do not disclose means for solving the above-described problems.

### SUMMARY OF THE INVENTION

It is an object of the present invention to provide an MR element, a thin film magnetic head, a magnetic head apparatus and a magnetic recording/reproducing apparatus in which a change in direction of an exchange coupling magnetic field between an anti-ferromagnetic layer and a ferromagnetic layer is not changed and hence reversal of magnetization in a pinned layer does not occur even if a stress is applied in, e.g., a polishing process.

To achieve this aim, an MR element according to the present invention comprises an anti-ferromagnetic layer, a first ferromagnetic layer (a pinned layer), a free layer and a non-magnetic layer. The first ferromagnetic layer is adjacently exchange-coupled with the anti-ferromagnetic layer. The free layer is an external magnetic field response layer, and the non-magnetic layer is positioned between the first ferromagnetic layer and the free layer. The first ferromagnetic layer has a saturation magnetostriction of (+3)×10⁻⁵ or less, and an exchange coupling magnetic field Hex between the first ferromagnetic layer and the anti-ferromagnetic layer is not less than 48 (kA/m).

By satisfying the above-described conditions, a direction of the exchange coupling magnetic field between the anti-ferromagnetic layer and the ferromagnetic layer does not vary even after a polishing process, and magnetization reversal is not produced in the first ferromagnetic layer. Therefore, in a single-film structure, when a product is cut from a wafer and manufactured into an individual body through polishing, a magnetization direction of the first ferromagnetic layer can be matched with a magnetization direction in the characteristic measurement on the wafer, thereby assuring predetermined electrical/magnetic characteristics.

It is to be noted that adjacency includes direct contact as well as indirect contact through another layer insofar as the function is not deteriorated.

The present invention can be applied to not only an MR element having an SV film but also an MR element having a TMR element. The non-magnetic layer positioned between the first ferromagnetic layer and the free layer comprises an electromagnetic layer of, e.g., Cu in case of the SV film, and it comprises an insulating layer of, e.g., aluminum oxide in case of the TMR film.

The present invention can be also applied to an MR element having a synthetic pinned layer. The MR element having the synthetic pinned layer comprises an anti-ferromagnetic layer, a first ferromagnetic layer, a non-magnetic intermediate layer, a second ferromagnetic layer, a free layer and a non-magnetic layer.

One surface of the first ferromagnetic layer is adjacently exchange-coupled with one surface of the anti-ferromagnetic layer, and one surface of the non-magnetic intermediate layer is adjacent to the other surface of the first ferromagnetic layer. One surface of the second ferromagnetic layer is adjacent to the other surface of the non-magnetic intermediate layer, and one surface of the non-magnetic layer is adjacent to the other surface of the second ferromagnetic layer. One surface of the free layer is adjacent to the other surface of the non-magnetic layer.

The MR element adopting the synthetic pinned layer can reduce a leakage magnetic field to zero in principle, and readily and securely assure an operating point.

According to the present invention, in the MR element adopting the synthetic pinned layer, it is determined that a saturation magnetostriction of the first ferromagnetic layer is not more than (+3)×10⁻⁵ and an exchange coupling magnetic field Hex between the first ferromagnetic layer and the anti-ferromagnetic layer is not less than 48 (kA/m).

According to the above-described configuration, a direction of the exchange coupling magnetic field between the anti-ferromagnetic layer and the first ferromagnetic layer does not vary even after the polishing process, and no magnetization reversal is produced in the first ferromagnetic layer. Therefore, when a product is cut from a wafer and manufactured into an individual body through polishing, a magnetization direction of the first ferromagnetic layer which is adjacent to the anti-ferromagnetic layer can be matched with a magnetization direction at the time of the characteristic measurement of the wafer, thereby assuring predetermined electrical/magnetic characteristics.

The present invention can be further applied to a dual type MR element. The dual type MR element comprises a first anti-ferromagnetic layer, a first ferromagnetic layer, a first non-magnetic intermediate layer, a second ferromagnetic layer, a first non-magnetic layer, a free layer, a second non-magnetic layer, a third ferromagnetic layer, a second non-magnetic intermediate layer, a fourth ferromagnetic layer, and a second anti-ferromagnetic layer.

An upper surface of the first ferromagnetic layer is adjacently exchange-coupled with a lower surface of the first anti-ferromagnetic layer, and an upper surface of the first non-magnetic intermediate layer is adjacent to a lower surface of the first ferromagnetic layer. An upper surface of the second ferromagnetic layer is adjacent to a lower surface of the first non-magnetic intermediate layer, an upper surface of the first non-magnetic layer is adjacent to a lower surface of the second ferromagnetic layer, and an upper surface of the free layer is adjacent to a lower surface of the first non-magnetic layer. Further, the first ferromagnetic layer, the first non-magnetic intermediate layer and the second ferromagnetic layer constitute a first synthetic pinned layer.

Furthermore, an upper surface of the second non-magnetic layer is adjacent to a lower surface of the free layer, an upper surface of the third ferromagnetic layer is adjacent to a lower surface of the second non-magnetic layer, and an upper surface of the second non-magnetic intermediate layer is adjacent to a lower surface of the third ferromagnetic layer. An upper surface of the fourth ferromagnetic layer is adjacent to a lower surface of the second non-magnetic intermediate layer, and an upper surface of the second anti-ferromagnetic layer is adjacently exchange-coupled with a lower surface of the fourth ferromagnetic layer. Moreover, the third ferromagnetic layer, the second non-magnetic intermediate layer and the fourth ferromagnetic layer constitute a second synthetic pinned layer.

In this example, it is determined that a saturation magnetostriction of the first ferromagnetic layer is not greater than (+3)×10⁻⁵ and an exchange coupling magnetic field Hex between the first ferromagnetic layer and the first anti-ferromagnetic layer is not less than 48 (kA/m).

Each of the first non-magnetic layer and the second non-magnetic layer comprises an electroconductive layer of, e.g., Cu in case of an SV film, and comprises an insulating layer of, e.g., aluminum oxide in case of a TMR film layer.

Since the dual type MR element has two synthetic pinned layers, a leakage magnetic field can be reduced to zero in principle, thereby readily and securely assuring an operating point.

In the dual type MR element, as already described above, when a stress is applied due to, e.g., a damage in a polishing process or an actual use condition, a direction of the exchange coupling magnetic field is not changed in the synthetic pinned layer placed on the upper side, but magnetization reversal is produced in the pinned layer.

In the present invention, since it is possible to satisfy the conditions that the saturation magnetostriction is not greater than (+3)×10⁻⁵ in the first ferromagnetic layer which is positioned on the upper side and achieves exchange coupling with the anti-ferromagnetic layer and the exchange coupling magnetic field Hex between the first ferromagnetic layer and the anti-ferromagnetic layer is not less than 48 (kA/m), a direction of the exchange coupling magnetic field between the anti-ferromagnetic layer and the first ferromagnetic layer is not changed even after the polishing process, and hence no magnetization reversal occurs in the first ferromagnetic layer. Therefore, when a product is cut from a wafer and manufactured into an individual body through polishing, a magnetization direction of the first ferromagnetic layer which is adjacent to the anti-ferromagnetic layer can be matched with a magnetization direction in the characteristic measurement on the wafer, thereby assuring predetermined electrical/magnetic characteristics.

Additionally, even if a film thickness of the first ferromagnetic layer is increased/reduced, the above conditions can be satisfied by controlling a composition ratio or the like of materials constituting the first ferromagnetic layer. Therefore, even if a film thickness of the first ferromagnetic layer is increased/reduced, magnetization reversal can be prevented from occurring in the first ferromagnetic layer. A film thickness of the first ferromagnetic layer falls within a range of 1 to 2 (nm).

In this type of MR element, the ferromagnetic layer which is adjacent to the anti-ferromagnetic layer is generally formed of CoFe even if any one of the single-layer structure, the synthetic pinned layer and the dual structure is adopted. In this case, if a film thickness of the ferromagnetic layer adjacent to the anti-ferromagnetic layer falls within a general range of 1 to 2 nm, it is possible to meet the conditions that the saturation magnetostriction is not more than (+3)×10⁻⁵ and the exchange coupling magnetic field Hex is not less than 48 (kA/m) by satisfying the following expression as CoₓFe_{y}.
14.5 (at %)≦X≦35.1 (at %)
When the film thickness of the ferromagnetic layer which is adjacent to the anti-ferromagnetic layer is changed, the above conditions can be satisfied by changing a value of a Co content ratio X.

Further, the present invention also discloses a thin film magnetic head, a magnetic head apparatus and a magnetic recording/reproducing apparatus using the above-described MR element.

As described above, according to the present invention, it is possible to provide an MR element, a thin film magnetic head, a magnetic head apparatus and a magnetic recording/reproducing apparatus in which a direction of an exchange coupling magnetic field between an anti-ferromagnetic layer and a ferromagnetic layer is not changed and magnetization of a pinned layer is not reversed even if a stress is applied in, e.g., a polishing process.

Further, when the present invention is applied to a dual type MR element having a synthetic pinned layer, it is possible to provide an MR element, a thin film magnetic head, a magnetic head apparatus and a magnetic recording/reproducing apparatus which can avoid a reduction in an MR ratio and a reproduction output and improve a yield even if a stress is applied in a polishing process or the like.

Any other object, structure and advantage of the present invention will be described in further detail with reference to the accompanying drawings. The accompanying drawings only show examples.

### BRIEF DESCRIPTION OF THE DRAWINGS

FIG. 1 is a view showing a film structure of an MR element according to the present invention;

FIG. 2 is a view showing another film structure of the MR element according to the present invention;

FIG. 3 is a view showing still another film structure of the MR element according to the present invention;

FIG. 4 is a plan view of a thin film magnetic head according to the present invention on a medium-opposing surface side;

FIG. 5 is a front cross-sectional view of the thin film magnetic head depicted in FIG. 4;

FIG. 6 is an enlarged cross-sectional view of an element part of the thin film magnetic head depicted in FIGS. 4 and 5;

FIG. 7 is a view showing an embodiment when the MR element depicted in FIG. 3 is used;

FIG. 8 is a front view of a magnetic head apparatus according to the present invention;

FIG. 9 is a bottom plan view of the magnetic head apparatus depicted in FIG. 8; and

FIG. 10 is a perspective view of a magnetic recording/reproducing apparatus using the magnetic head apparatus depicted in FIGS. 8 and 9.

### DESCRIPTION OF THE PREFERRED EMBODIMENTS

1. MR Element

(1) MR Element Having Single-Layer Film Structure

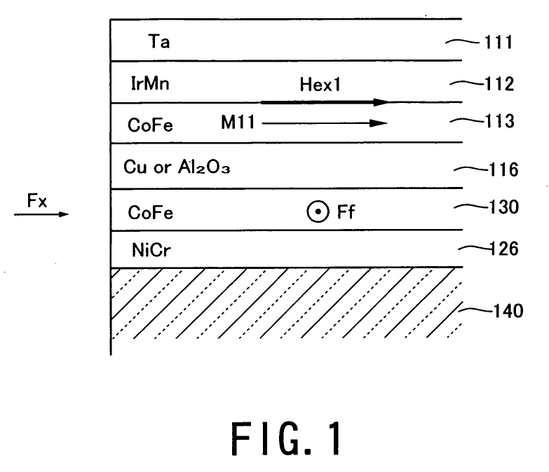

FIG. 1 is a view showing a film structure of an MR element according to the present invention. This MR element includes an SV film or a TMR film, and can be used for a magnetic storage element, a magnetic sensor, a thin film magnetic head or the like. The illustrated MR element comprises an anti-ferromagnetic layer 112, a first ferromagnetic layer 113, a non-magnetic layer 116 and a free layer 130.

An upper surface of the first ferromagnetic layer 113 is adjacently exchange-coupled with a lower surface of the anti-ferromagnetic layer 112, thereby generating an exchange coupling magnetic field Hex1. A magnetization direction M11 of the first ferromagnetic layer 113 is fixed by the exchange coupling magnetic field Hex1. The anti-ferromagnetic layer 112 is formed of a known material such as PtMn, IrMn, NiMn or PtMnCr. An upper surface of the anti-ferromagnetic layer 112 is covered with a protection film 111 formed of, e.g., Ta.

The first ferromagnetic layer 113 consists of CoFe, NiFe or CoFeNi or a laminated structure or the like containing two or more materials selected from these materials. In the embodiment, the description will be given provided that the anti-ferromagnetic layer 112 consists of IrMn and the first ferromagnetic layer 113 consists of CoFe.

An upper surface of the non-magnetic layer 116 is adjacent to a lower surface of the first ferromagnetic layer 113. The non-magnetic layer 116 consists of, e.g., Cu in case of an SV film, and consists of aluminum oxide (Al₂O₃) obtained by oxidizing aluminum in case of a TMR film.

An upper surface of the free layer 130 is adjacent to a lower surface of the non-magnetic layer 116. Like the first ferromagnetic layer 113, the free layer 130 may consist of CoFe, NiFe or CoFeNi or a laminated structure containing two or more materials selected from these materials. In the embodiment, the description will be given provided that the free layer 130 consists of CoFe. The free layer 130 is laminated on an underlying film 126 formed on a substrate 140 composed of an electrically insulating substance such as alumina. The underlying film 126 consists of NiCr or the like.

Although not shown, the film structure may be inverted. Furthermore, when the SV film is used in the film structure, the film structure may be of a type in which a sense current flows in parallel with a film surface or a type in which a sense current flows vertically with respect to the film surface. In case of the TMR film, a sense current flows vertically with respect to the film surface.

In the MR element, when a magnetization direction of the free layer 130 is rotated in response to an external magnetic field Fx, a resistance value with respect to a sense current passing through the non-magnetic layer 116 greatly changes in response to a rotation angle of the magnetization direction of the free layer 130 with respect to a fixed magnetization direction M11 in the first ferromagnetic layer 113. Characteristics such as an output of a thin film magnetic head or the like are determined by an angle formed by the magnetization direction M11 of the first ferromagnetic layer 113 and the magnetization direction of the free layer 130.

Here, the first ferromagnetic layer 113 is set in such a manner that a saturation magnetostriction thereof is not more than (+3)×10⁻⁵ and an exchange coupling magnetic field Hex between itself and the anti-ferromagnetic layer 112 is not less than 48 (kA/m).

When the above-described conditions are satisfied, a direction of the exchange coupling magnetic field Hex between the anti-ferromagnetic layer 112 and the first ferromagnetic layer 113 is not changed and the magnetization direction M11 of the first ferromagnetic layer 113 is not reversed even after the polishing process. Therefore, in the single-film structure, the magnetization direction of the first ferromagnetic layer 113 when a product is cut from a wafer and manufactured into an individual body through the polishing process can be matched with the magnetization direction M11 of the first ferromagnetic layer 113 at the time of characteristic measurement on the wafer, and predetermined electrical/magnetic characteristics can be assured. This point will be described later with reference to data.

(2) MR Element Having Synthetic Pinned Layer

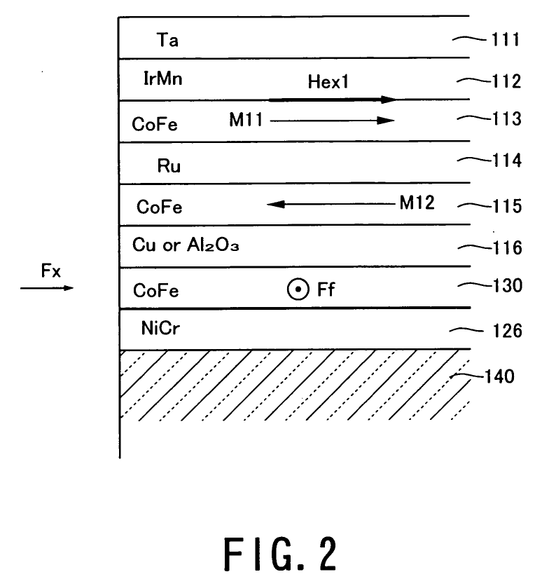

FIG. 2 is a view showing a film structure of an MR element having a synthetic pinned layer. This MR element can be likewise used for a magnetic storage element, a magnetic sensor, a thin film magnetic head or the like. The illustrated MR element comprises an anti-ferromagnetic layer 112, a first ferromagnetic layer 113, a non-magnetic intermediate layer 114, a second ferromagnetic layer 115, a non-magnetic layer 116 and a free layer 130. An upper surface of the anti-ferromagnetic layer 112 is covered with a protection film 111 formed of Ta or the like. Furthermore, the first ferromagnetic layer 113, the non-magnetic intermediate layer 114 and the second ferromagnetic layer 115 constitute a synthetic pinned layer.

An upper surface of the first ferromagnetic layer 113 is adjacently exchange-coupled with a lower surface of the anti-ferromagnetic layer 112, thereby generating an exchange coupling magnetic field Hex1. The first ferromagnetic layer 113 is fixed in a magnetization direction M11 by the exchange coupling magnetic field Hex1. The anti-ferromagnetic layer 112 consists of a known material such as PtMn, IrMn, NiMn, PtMnCr or the like.

The first ferromagnetic layer 113 consists of CoFe, Nife or CoFeNi or a laminated layer containing two or more materials selected from these materials. In the embodiment, the description will be given provided that the anti-ferromagnetic layer 112 consists of IrMn and the first ferromagnetic layer 113 consists of CoFe.

An upper surface of the non-magnetic intermediate layer 114 is adjacent to a lower surface of the first ferromagnetic layer 113. The non-magnetic intermediate layer 114 consists of ruthenium Ru or the like.

An upper surface of the second ferromagnetic layer 115 is adjacent to a lower surface of the non-magnetic intermediate layer 114. The second ferromagnetic layer 115 also consists of CoFe, NiFe or CoFeNi or a laminated structure containing two or more materials selected from these materials like the first ferromagnetic layer 113. In the embodiment, the description will be given provided that the second ferromagnetic layer 115 consists of CoFe.

The first ferromagnetic layer 113 and the second ferromagnetic layer 115 are exchange-coupled with each other so that their magnetization directions M11 and M12 become anti-parallel through the non-magnetic intermediate layer 114. Therefore, the magnetization direction M12 in the second ferromagnetic layer 115 is fixed to a direction opposite to the magnetization direction M11 of the first ferromagnetic layer 113 obtained by the exchange coupling magnetic field Hex1. Moreover, since intensive exchange coupling is achieved between the first ferromagnetic layer 113 and the second ferromagnetic layer 115, the exchange coupling force from the anti-ferromagnetic layer 112 can be effectively increased.

An upper surface of the non-magnetic layer 116 is adjacent to a lower surface of the second ferromagnetic layer 115. The non-magnetic layer 116 consists of, e.g., Cu in case of an SV film, and consists of aluminum oxide in case of a TMR film.

An upper surface of the free layer 130 is adjacent to a lower surface of the non-magnetic layer 116. The free layer 130 also consists of CoFe, NiFe or CoFeNi or a laminated structure containing two or more materials selected from these materials like the first ferromagnetic layer 113 and the second ferromagnetic layer 115. In the embodiment, the description will be given provided that the free layer 130 consists of CoFe.

The MR element adopting the synthetic pinned layer can reduce a leakage magnetic field to zero in principle and readily and securely assure an operating point. In the present invention, the first ferromagnetic layer 113 is set so that a saturation magnetostriction becomes not greater (+3)×10⁻⁵ and the exchange coupling magnetic field Hex1 between itself and the anti-ferromagnetic layer 112 becomes not less than 48 (kA/m) in the MR element adopting the synthetic pinned layer.

According to the above-described structure, the direction of the exchange coupling magnetic field Hex1 between the anti-ferromagnetic layer 112 and the first ferromagnetic layer 113 is not changed and magnetization reversal does not occur in the first ferromagnetic layer 113 even after the polishing process. Therefore, the magnetization directions of the first and second ferromagnetic layers 113 and 115 when a product is cut from a wafer and manufactured into an individual body after the polishing process can be matched with the magnetization directions in the characteristic measurement on the wafer, and predetermined electrical/magnetic characteristics can be assured. Although not shown, the film structure may be inverted.

(3) Dual Type MR Element

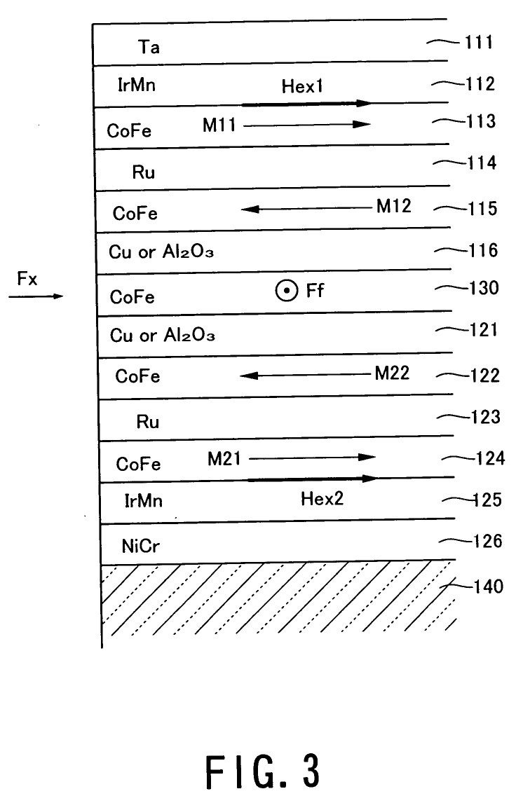

FIG. 3 is a view showing a film structure of a dual type MR element according to the present invention. This MR element can be likewise used for a magnetic storage element, a magnetic sensor, a thin film magnetic head or the like. The illustrated dual type MR element first comprises a first anti-ferromagnetic layer 112, a first ferromagnetic layer 113, a first non-magnetic intermediate layer 114, a second ferromagnetic layer 115, a first non-magnetic layer 116 and a free layer 130. An upper surface of the first anti-ferromagnetic layer 112 is covered with a protection film 111 consisting of Ta or the like. Additionally, the first ferromagnetic layer 113, the first non-magnetic intermediate layer 114 and the second ferromagnetic layer 115 constitute a first synthetic pinned layer.

An upper surface of the first ferromagnetic layer 113 is adjacently exchange-coupled with a lower surface of the first anti-ferromagnetic layer 112, thereby generating an exchange coupling magnetic field Hex1. The first ferromagnetic layer 113 is magnetized in a magnetization direction M11 by the exchange coupling magnetic field Hex1. The anti-ferromagnetic layer 112 consists of a know material such as PtMn, IrMn, NiMn or PtMnCr.

The first ferromagnetic layer 113 consists of CoFe, NiFe or CoFeNi or a laminated structure containing two or more materials selected from these materials. In the embodiment, the description will be given provided that the anti-ferromagnetic layer 112 consists of IrMn and the first ferromagnetic layer 113 consists of CoFe.

An upper surface of the first non-magnetic intermediate layer 114 is adjacent to a lower surface of the first ferromagnetic layer 113. The first non-magnetic intermediate layer 114 consists of ruthenium Ru or the like.

An upper surface of the second ferromagnetic layer 115 is adjacent to a lower surface of the first non-magnetic intermediate layer 114. The second ferromagnetic layer 115 also consists of CoFe, NiFe or CoFeNi or a laminated structure containing two or more materials selected from these materials like the first ferromagnetic layer 113. In the embodiment, the description will be given provided that the second ferromagnetic layer 115 consists of CoFe.

The first ferromagnetic layer 113 and the second ferromagnetic layer 115 are exchange-coupled with each other through the first non-magnetic intermediate layer 114 in such a manner that their magnetization directions M11 and M12 become anti-parallel. Therefore, the magnetization direction M12 in the second ferromagnetic layer 115 is fixed to a direction opposite to the magnetization direction M11 of the first ferromagnetic layer 113 obtained by the exchange coupling magnetic field Hex1. Further, since intensive exchange coupling is achieved between the first ferromagnetic layer 113 and the second ferromagnetic layer 115, an exchange coupling force from the anti-ferromagnetic layer 112 can be effectively increased.

An upper surface of the first non-magnetic layer 116 is adjacent to a lower surface of the second ferromagnetic layer 115. The first non-magnetic layer 116 consists of, e.g., Cu in case of an SV film, and consists of aluminum oxide (Al₂O₃) obtained by oxidizing aluminum in case of a TMR film.

An upper surface of the free layer 130 is adjacent to a lower surface of the first non-magnetic layer 116. The free layer 130 also consists of CoFe, NiFe or CoFeNi or a laminated structure containing two or more materials selected from these materials like the first ferromagnetic layer 113 and the second ferromagnetic layer 115. In the embodiment, the description will be given provided that the free layer 130 consists of CoFe.

The dual type MR element depicted in FIG. 3 further comprises a second non-magnetic layer 121, a third ferromagnetic layer 122, a second non-magnetic intermediate layer 123, a fourth ferromagnetic layer 124, and a second anti-ferromagnetic layer 125. Furthermore, the third ferromagnetic layer 122, the second non-magnetic intermediate layer 123 and the fourth ferromagnetic layer 124 constitute a second synthetic pinned layer.

An upper surface of the second non-magnetic layer 121 is adjacent to a lower surface of the free layer 130. The second non-magnetic layer 121 consists of, e.g., Cu in case of an SV film, and consists of aluminum oxide (Al₂O₃) in case of a TMR film.

An upper surface of the third ferromagnetic film 122 is adjacent to a lower surface of the second non-magnetic layer 121. The third ferromagnetic layer 122 consists of CoFe, NiFe or CoFeNi or a laminated layer containing two or more materials selected from these materials. In the embodiment, the description will be given provided that the third ferromagnetic layer 122 consists of CoFe.

An upper surface of the second non-magnetic intermediate layer 123 is adjacent to a lower surface of the third ferromagnetic layer 122. The second non-magnetic intermediate layer 123 consists of Ru or the like.

An upper surface of the fourth ferromagnetic layer 124 is adjacent to a lower surface of the second non-magnetic intermediate layer 123. The fourth ferromagnetic layer 124 consists of CoFe, NiFe or CoFeNi or a laminated structure containing two or more materials selected from these materials. In the embodiment, the description will be given provided that the fourth ferromagnetic layer 124 consists of CoFe.

An upper surface of the second anti-ferromagnetic layer 125 is adjacently exchange-coupled with a lower surface of the fourth ferromagnetic layer 124, thereby generating an exchange coupling magnetic field Hex2. The fourth ferromagnetic layer 124 is fixed in a magnetization direction M21 by the exchange coupling magnetic field Hex2. This second anti-ferromagnetic layer 125 is laminated on an underlying film 126 formed on a substrate 140 consisting of an electrically insulating substance such as alumina. The underlying film 126 consists of NiCr or the like.

The third ferromagnetic layer 122 and the fourth ferromagnetic layer 124 are exchange-coupled with each other through the second non-magnetic intermediate layer 123 so that their magnetization directions M21 and M22 become anti-parallel. Therefore, the magnetization direction M22 in the third ferromagnetic layer 122 is fixed to a direction opposite to the magnetization direction M21 of the fourth ferromagnetic layer 124 obtained by the exchange coupling magnetic field Hex2. Furthermore, since intensive exchange coupling is achieved between the third ferromagnetic layer 122 and the fourth ferromagnetic layer 124, an exchange coupling force from the second anti-ferromagnetic layer 125 can be effectively increased.

A direction of the exchange coupling magnetic field Hex2 matches with a direction of the exchange coupling magnetic field Hex1. Therefore, the magnetization direction M21 induced by the exchange coupling magnetic field Hex2 matches with the magnetization direction M11 induced by the exchange coupling magnetic field Hex1. Moreover, the magnetization direction opposite to the magnetization direction M21 matches with the magnetization direction M12 opposite to the magnetization direction M11 in direction.

In the dual SV film structure described above, when the magnetization direction of the free layer 130 rotates in response to an external magnetic field Fx, a resistance value with respect to a sense current flowing through the first and second non-magnetic layers 116 and 121 greatly changes in accordance a rotation angle of the magnetization direction of the free layer 130 with respect to the fixed magnetization directions M12 and M22 in the second ferromagnetic layer 115 and the third ferromagnetic layer 122. Characteristics such as an output of a thin film magnetic head or the like are determined by directions of the magnetization direction M12 of the second ferromagnetic layer 115 and the magnetization direction M22 of the third ferromagnetic layer 122 and an angle formed by the magnetization direction of the free layer 130.

Since the dual SV film according to the embodiment adopts the synthetic pinned layer, a leakage magnetic field can be reduced to zero in principle, and an operating point can be easily and securely assured. Moreover, since the dual SV film is provided, a high MR ratio can be obtained. In the dual SV film, the second ferromagnetic layer 115 and the third ferromagnetic layer 122 must have the same magnetization direction.

However, as described above, when a stress is applied due to a damage or the like in a polishing process or an actual use state, a direction of the exchange coupling magnetic filed Hex2 acting on the second synthetic pinned layer is not changed and the magnetization directions of the fourth ferromagnetic layer 124 and the third ferromagnetic layer 122 remain unchanged, whereas a direction of the exchange coupling magnetic field Hex1 acting on the first synthetic pinned layer is changed, and magnetization reversal occurs in the first ferromagnetic layer 113 and the second ferromagnetic layer 115, which results in a problem of an extreme reduction in MR ratio and reproduction output and a great reduction in yield, thereby considerably decreasing the reliability.

Thus, as a countermeasure for this problem, the present invention satisfies the conditions that the first ferromagnetic layer 113 has a saturation magnetostriction which is not greater than (+3)×10⁻⁵ and an exchange coupling magnetic field Hex between itself and the first anti-ferromagnetic layer 112 which is not less than 48 (kA/m).

When the above-described conditions are satisfied, it was confirmed that the direction of the exchange coupling magnetic field Hex1 of the first synthetic pinned layer is not changed, no magnetization reversal occurs in the first ferromagnetic layer 113 and the second ferromagnetic layer 115 and the magnetization direction of the second ferromagnetic layer 115 can be maintained to match with the magnetization direction of the third ferromagnetic layer 122 even after the polishing process.

Additionally, even if a film thickness of the first ferromagnetic layer 113 is increased/decreased, the above-described conditions can be satisfied by controlling a composite ratio or the like of materials constituting the first ferromagnetic layer 113. Therefore, even if a film thickness of the first ferromagnetic layer 113 is increased/decreased, magnetization reversal can be prevented from being generated in the first ferromagnetic layer 113.

The first ferromagnetic layer 113 generally consists of CoFe. In this case, if a film thickness of the first ferromagnetic layer 113 falls within a general range of 1 to 2 nm, it is possible to satisfy the conditions that the saturation magnetostriction is not greater than (+3)×10⁻⁵ and the exchange coupling magnetic field Hex is not less than 48 (kA/m) by meeting the following expression as CoₓFe_{y}:
14.5 (at %)≦X≦35.1 (at %)
This point will now be described with reference to data in Table 1.

Data in Table 1 is data showing a relationship between a Co content ratio X (at %), a film thickness (nm), a saturation magnetostriction and an exchange coupling magnetic field Hex1 and a defective fraction when the first ferromagnetic layer 113 consists of CoₓFe_{y}. As to the defective fraction, in 200 sample pieces of each of Samples 1 to 13, samples from which a reproduction output is rarely produced are determined as defective products. A film thickness (nm) is set to a fixed value 1.5 (nm) but a Co content ratio x (at %) is changed in Samples 1 to 11, and a film thickness (nm) is set to 1.2 (nm) and a Co content ratio (at %) is set to 69.4 (at %) and 35.1 (at %) in Samples 12 and 13.

TABLE 1

| | First ferromagnetic layer | | | | |
|---|---|---|---|---|---|
| | Co | | | | |
| | content | | Saturation | | Defective |
| Sample | ratio | Thickness | magnetostriction | Hex1 | fraction |
| No. | (at %) | (nm) | (10⁻⁵) | (kA/m) | (%) |
| 1 | 10.2 | 1.5 | 1.23 | 30.0 | 15.3 |
| 2 | 14.5 | 1.5 | 1.59 | 49.9 | 2.9 |
| 3 | 22.2 | 1.5 | 2.01 | 64.0 | 2.5 |
| 4 | 35.1 | 1.5 | 2.93 | 76.1 | 1.9 |
| 5 | 44.2 | 1.5 | 4.40 | 85.3 | 9.8 |
| 6 | 54.3 | 1.5 | 5.07 | 95.1 | 15.4 |
| 7 | 66.9 | 1.5 | 4.47 | 96.3 | 12.6 |
| 8 | 69.4 | 1.5 | 4.15 | 57.9 | 8.6 |
| 9 | 74.0 | 1.5 | 3.81 | 37.2 | 20.3 |
| 10 | 82.9 | 1.5 | 1.37 | 30.4 | 17.2 |
| 11 | 87.2 | 1.5 | 1.90 | 27.3 | 22.2 |
| 12 | 69.4 | 1.2 | 2.65 | 71.7 | 2.8 |
| 13 | 35.1 | 1.2 | 1.73 | 88.8 | 1.3 |

Considering defective fractions of Samples 1 to 13 in Table 1 on the assumption that an upper limit of the defective fraction is not greater than 3% which is allowed for mass production at any rate, of Samples 1 and 5 to 11, Sample 8 has the lowest defective fraction of 8.6 (%), and Sample 11 has the worst defective fraction of 22.2 (%), which implies that the predetermined defective fraction is not satisfied.

Giving a further consideration in accordance with each sample, although a saturation magnetostriction of Sample 1 is (1.23×10⁻⁵) which satisfies the condition of (+3)×10⁻⁵ of the present invention, but an exchange coupling magnetic field Hex1 of the same is 30.0 (kA/m) which does not satisfy the condition “the exchange coupling magnetic field Hex is not less than 48 (kA/m)” of the present invention, and the defective fraction reaches 15.3 (%).

Next, Samples 5 to 8 satisfy the condition “the exchange coupling magnetic field Hex is not less than 48 (kA/m)”, but do not meet the condition “the saturation magnetostriction is not greater than (+3)×10⁻⁵”, and their defective fractions reach 8.6 to 15.4 (%).

Sample 9 does not satisfy either the condition “the exchange coupling magnetic field Hex is not less than 48 (kA/m)” or the condition “the saturation magnetostriction is not greater than (+3)×10⁻⁵”, and its defective fraction reaches 20.3 (%).

Samples 10 and 11 satisfy the condition “the saturation magnetostriction is not greater than (+3)×10⁻⁵” but do not satisfy the condition “the exchange coupling magnetic field Hex is not less than 48 (kA/m)”, and their defective fractions reach 17.2 (%) and 22.2 (%).

On the other hand, Samples 2 to 4 meeting the conditions “the saturation magnetostriction is not greater than (+3)×10⁻⁵” and “the exchange coupling magnetic field Hex is not less than 48 (kA/m)” have the defective fractions which are as very low as 1.9 to 2.9 (%), and they demonstrate the obvious superiority with respect to Samples 1 and 5 to 11.

Further considering about Sample 2 to 4, their Co content ratios are 14.5 (at %), 22.2 (at %) and 35.1 (at %), respectively. That is, in cases where the first ferromagnetic layer 113 is formed of an alloy represented as CoₓFe_{y}, the saturation magnetostriction can be set to (+3)×10⁻⁵ or less and the exchange coupling magnetic filed Hex can be set to 48 (kA/m) or more, if the Co content ratio falls within the following range:
14.5 (at %)≦X≦35.1 (at %).

Samples 2 to 4 have a film thickness of 1.5 nm. The first ferromagnetic layer 113 in question usually has a film thickness falling within a range of 1 to 2 nm in case of this type of SV film, and hence selecting an intermediate value 1.5 nm as a typical value is rational.

When a film thickness is changed, the saturation magnetostriction can be set to (+3)×10⁻⁵ or less and the exchange coupling magnetic field Hex can be set to 48 (kA/m) or more by controlling a Co content ratio. Samples 12 and 13 in Table 1 imply this fact.

First, in case of Sample 12, when the first ferromagnetic layer 113 is formed of an alloy which has a film thickness of 1.2 nm and is represented as CoₓFe_{y}, it is indicated that the saturation magnetostriction can be set to (+2.65)×10⁻⁵ which is not greater than (+3)×10⁻⁵, the exchange coupling magnetic field Hex1 can be set to 71.7 (kA/m) which corresponds to 48 (kA/m) or more and the defective fraction can be suppressed to 2.8% by setting the Co content ratio X to 69.4 (at %).

In case of Sample 13, the saturation magnetostriction can be set to (+1.73)×10⁻⁵ which is not greater than (+3)×10⁻⁵, the exchange coupling magnetic field Hex1 can be set to 88.8 (kA/m) which corresponds to 48 (kA/m) or more and the defective fraction can be suppressed to 1.3% by setting the Co content ratio X to 35.1 (at %).

Although Table 1 shows the data of the dual SV film depicted in FIG. 3, the defective fraction arises from magnetization reversal of the first ferromagnetic layer caused due to a change in direction of the exchange coupling magnetic field Hex1 between the anti-ferromagnetic film 112 and the adjacent first ferromagnetic layer 113, and hence the data in Table 1 is also appropriate for the MR element depicted in FIGS. 1 and 2. Further, the embodiment shows the example in which the present invention is applied to the first ferromagnetic film 113 only, but the application to the fourth ferromagnetic film 124 is not excluded.

2. Thin Film Magnetic Head.

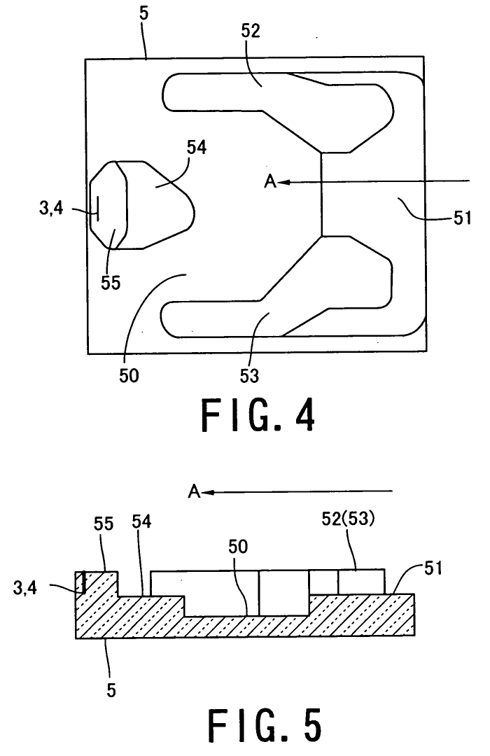

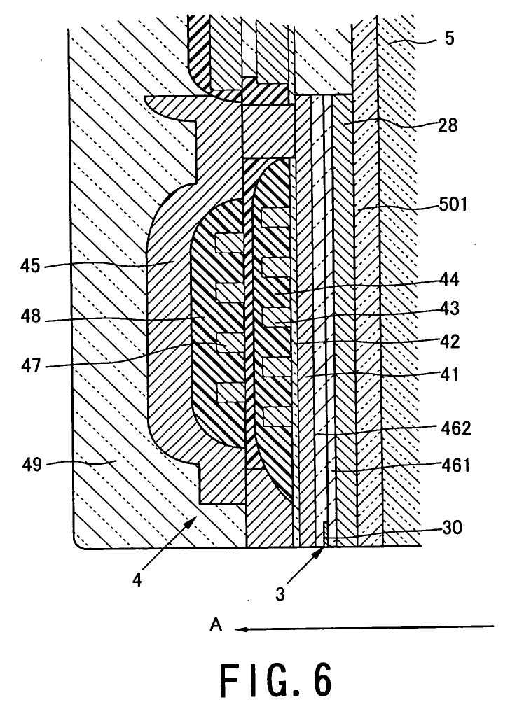

FIG. 4 is a plan view of a thin film magnetic head according to the present invention on a medium-opposing surface side, FIG. 5 is a front cross-sectional view of the thin film magnetic head depicted in FIG. 4, and FIG. 6 is an enlarged cross-sectional view of an element part of the thin film magnetic head depicted in FIGS. 4 and 5. In all the drawings, a dimension, a proportion and others are magnified or eliminated for the convenience's sake.

The illustrated thin film magnetic head comprises a slider base substance 5, a reproducing element 3 and a recording element 4. The slider base substance 5 consists of a ceramic material such as AlTiC (Al₂O₃—TiC), and has a geometric shape for controlling surfacing characteristics on the medium-opposing surface. As a typical example of such a geometric shape, the embodiment shows an example in which a first step portion 51, a second step portion 52, a third step portion 53, a fourth step portion 54 and a fifth step portion 55 are provided on a base bottom surface 50 of the slider base substance 5. The base bottom surface 50 serves as a negative pressure generation portion with respect to an air flow direction indicated by an arrow A, and the second step portion 52 and the third step portion 53 constitute a stepped air bearing rising from the first step portion 51.

The fourth step portion 54 rises from the base bottom surface 50 in a stepped form, and the fifth step portion 55 rises from the fourth step portion 54 in a stepped form. The reproducing element 3 and the recording element 4 are provided to the fifth step portion 55.

The recording element 4 is, e.g., an inductive magnetic conversion element, and its write magnetic pole end faces an ABS and is covered with a protection film 49.

The recording element 4 comprises a lower magnetic pole layer 41 which also functions as a second shield film, an upper magnetic pole layer 45, a recording gap layer 42 and thin film coils 43 and 47. The lower magnetic pole layer 41 is magnetically coupled with the upper magnetic pole layer 45. The recording gap layer 42 is provided between a magnetic pole portion of the lower magnetic pole layer 41 and a magnetic pole portion of the upper magnetic pole layer 45. The thin film coils 43 and 47 are arranged in insulating films 48 in an inner gap between the lower magnetic pole layer 41 and the upper magnetic pole layer 45 in an insulated state. Furthermore, the lower magnetic pole layer may be separately provided on the second shield film. The recording element 4 is not restricted to the above-described conformation, and a recording element which has been proposed or will be proposed can be extensively applied.

The reproducing element 3 comprises an MR element 30, a first shield layer 28, a first gap layer 461, a second gap layer 462 and a second shield layer 41 which serves as a lower magnetic pole layer, and these members are arranged between the recording element 4 and the slider base substance 5. The MR element 30 includes the SV film depicted in FIG. 3. Therefore, according to this embodiment, the effects and advantages of the MR element described with reference to FIG. 3 can be all obtained.

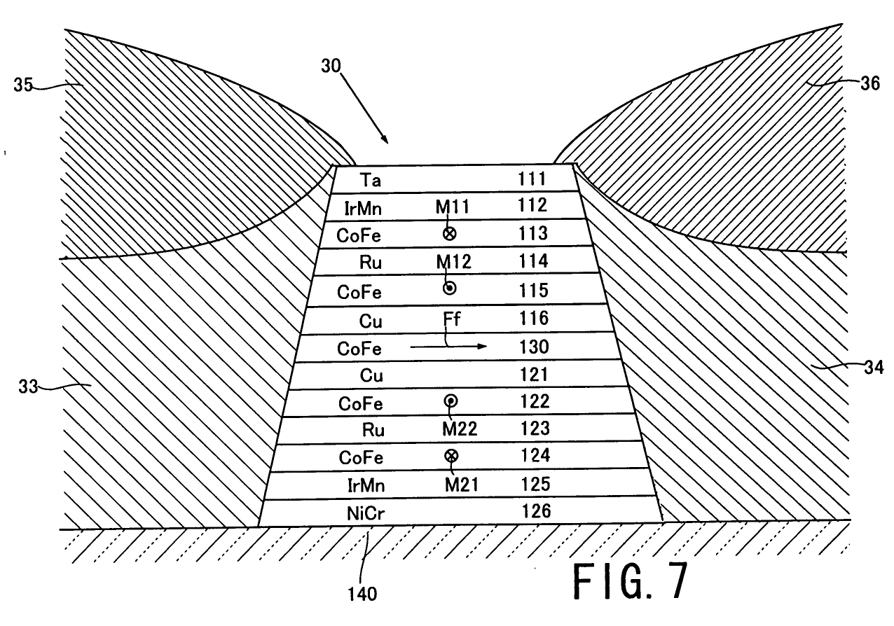

FIG. 7 shows an embodiment when the MR element depicted in FIG. 3 is used. FIG. 7 shows the MR element of FIG. 3 from the left-hand side, and magnetization directions M11, M12 M21 and M22 are provided in a direction vertical to the page space. The free layer 130 is magnetized in a direction of an arrow Ff. The MR element 30 is provided with magnetic domain control films 33 and 34 and lead electric pole films 35 and 36.

The magnetic domain control films 33 and 34 prevent Barkhausen noises of the free layer 130, and a hard magnetic film as well as an exchange coupling film between an anti-ferromagnetic film and a ferromagnetic layer can be used as these films. The lead electric pole films 35 and 36 are used to supply a sense current, and they consists of, e.g., Au.

As shown in FIG. 7 in an enlarged manner, the illustrated thin film magnetic head has the MR element depicted in FIG. 3, and hence demonstrates the effects and advantages described with reference to FIG. 3. Although not shown, the MR elements depicted in FIGS. 1 and 2 can be of course used. An electric pole structure varies depending on an SV film and a TMR film. Such an electric pole structure has been already known.

3. Magnetic Head Apparatus

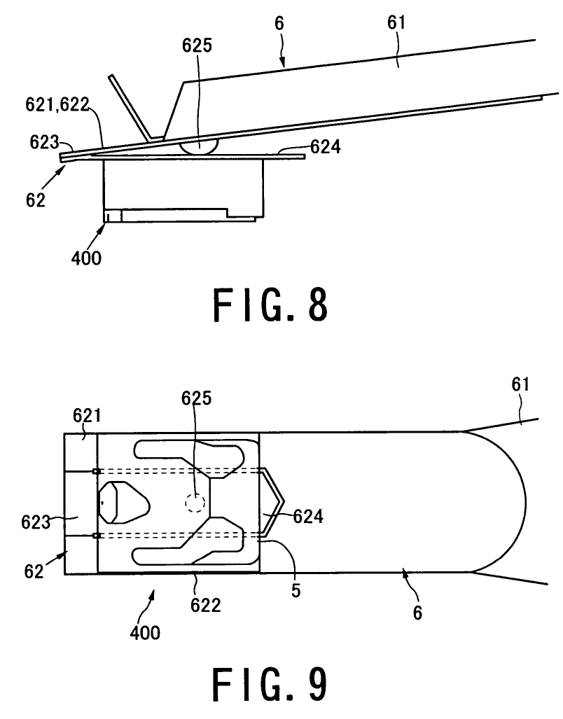

FIG. 8 is a front view of a magnetic head apparatus according to the present invention, and FIG. 9 is a bottom plan view of the magnetic head apparatus depicted in FIG. 8. The illustrated magnetic head apparatus comprises a thin film magnetic head 400 depicted in FIGS. 4 to 7 and a head support device 6. The head support device 6 has a structure in which a flexible body 62 formed of a sheet metal is attached at a free end positioned at one end of a support 61 likewise formed of a sheet metal in the longitudinal direction and the thin film magnetic head 400 is attached on a lower surface of the flexible body 62.

Specifically, the flexible body 62 has two outer frame portions 621 and 622 extending in substantially parallel with a longitudinal axial line of the support 61, a lateral frame 623 which couples the outer frame portions 621 and 622 with each other at an end apart from the support 61, and a tongue-like piece 624 which extends in substantially parallel with the outer frame portions 621 and 622 from a substantially central portion of the lateral frame 623 and has an end determined as a free end. One end of the lateral frame 623 opposite to a given direction is attached in the vicinity of the free end of the support 61 by means of, e.g., welding.

For example, a semispherical load protrusion 625 is provided on the lower surface of the support 61. A load force is transmitted from the free end of the support 61 to the tongue-like piece 624 by this load protrusion 625.

The thin film magnetic head 400 is attached on a lower surface of the tongue-like piece 624 by means of, e.g., an adhesive. The thin film magnetic head 400 is supported so that a pitch operation and a roll operation are allowed.

The head support device 6 which can be applied to the present invention is not restricted to the foregoing embodiment, and a head support device which has been proposed or will be proposed can be extensively applied. For example, it is possible to use a head support device in which the support 61 and the tongue-like piece 624 are integrated by using a flexible polymeric wiring board such as a tab tape (TAB). Moreover, a head support device having a conventionally known gimbal structure can be used without restraint.

The thin film magnetic head 400 has the MR element depicted in FIGS. 1 to 3 and has the structure illustrated in FIGS. 4 to 7, and hence the magnetic head apparatus shown in FIGS. 8 and 9 demonstrates the effects and advantages described with reference to FIG. 3.

4. Magnetic Recording/Reproducing Apparatus

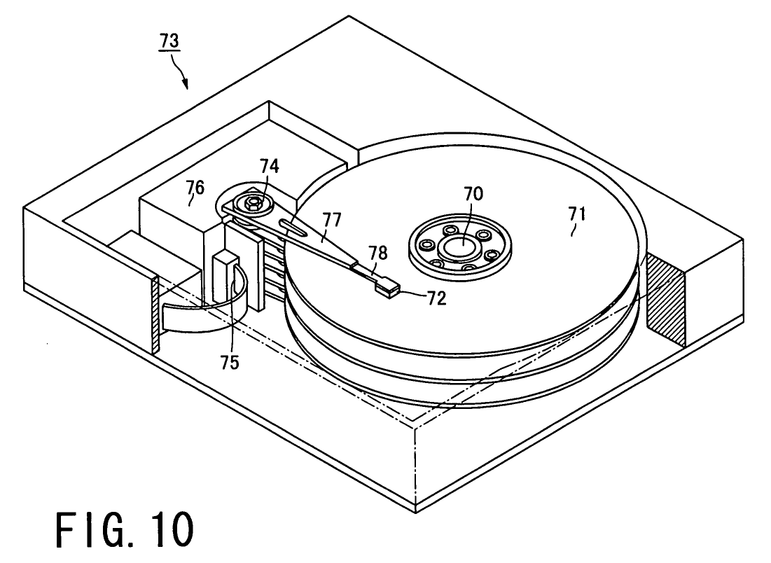

FIG. 10 is a perspective view of a magnetic recording/reproducing apparatus using the magnetic head apparatus depicted in FIGS. 8 and 9. The illustrated magnetic recording/reproducing apparatus comprises a magnetic disk 71 provided so as to be capable of rotating around a shaft 70, a thin film magnetic head 72 which records and reproduces information with respect to the magnetic disk 71, and an assembly carriage device 73 which positions the thin film magnetic head 72 on a track of the magnetic disk 71.

The assembly carriage device 73 is mainly constituted of a carriage 75 capable of swiveling around a shaft 74 and an actuator 76 composed of, e.g., a voice coil motor (VCM) which drives this carriage 75 to swivel.

Base portions of a plurality of drive arms 77 stacked in a direction of the shaft 74 are attached to the carriage 75, and a head suspension assembly 78 to which the thin film magnetic head 72 is mounted is secured to an end portion of each drive arm 77. Each head suspension assembly 78 is provided at an end portion of the drive arm 77 in such a manner that the thin film magnetic head 72 provided at the end portion of the head suspension assembly 78 is opposed to a surface of each magnetic disk 71.

The drive arm 77, the head suspension assembly 78 and the thin film magnetic head 72 constitute the magnetic head apparatus described with reference to FIGS. 8 and 9. The thin film magnetic head 72 has the MR element depicted in FIG. 3 and has the structure shown in FIGS. 4 and 7.

Therefore, the magnetic recording/reproducing apparatus depicted in FIG. 10 demonstrates the effects and advantages described with reference to FIGS. 3 and 9.

Although the content of the present invention has been concretely described in conjunction with the preferred embodiments, it is self-evident that a person skilled in the art can adopt various modified conformations based on basic technical concepts and teachings of the present invention.

1. A magneto-resistive element comprising: an anti-ferromagnetic layer; a first ferromagnetic layer; a free layer; and a non-magnetic layer,
wherein the first ferromagnetic layer is adjacently exchange-coupled with the anti-ferromagnetic layer,
the free layer is an external magnetic field response layer,
the non-magnetic layer is positioned between the first ferromagnetic layer and the free layer, and
the first ferromagnetic layer has a saturation magnetostriction which is not greater than (+3)×10⁻⁵ and an exchange coupling magnetic field Hex between itself and the anti-ferromagnetic layer which is not less than 48 (kA/m).

2. The magneto-resistive element according to claim 1, wherein a film thickness of the first ferromagnetic layer falls within a range of 1 to 2 (nm).

3. The magneto-resistive element according to claim 1, wherein the non-magnetic layer is an electroconductive layer.

4. The magneto-resistive element according to claim 1, wherein the non-magnetic layer is an insulating layer.

5. A thin film magnetic head comprising: a magneto-resistive element; and a slider,
wherein the magneto-resistive element is constituted of the magneto-resistive element according to claim 1, and
the slider supports the magneto-resistive element.

6. The thin film magnetic head according to claim 5, further comprising a writing element.

7. A magnetic head apparatus comprising: a thin film magnetic head; and a head support device,
wherein the thin film magnetic head is constituted of the thin film magnetic head according to claim 6, and
the head support device supports the thin film magnetic head.

8. A magnetic recording/reproducing apparatus comprising: a magnetic head apparatus; and a magnetic disk,
wherein the magnetic head apparatus is constituted of the magnetic head apparatus according to claim 7, and writes and reads a magnetic record on the magnetic disk.

9. A magneto-resistive element comprising: an anti-ferromagnetic layer; a first ferromagnetic layer; a non-magnetic intermediate layer; a second ferromagnetic layer; a non-magnetic layer; and a free layer,
wherein one surface of the first ferromagnetic layer is adjacently exchange-coupled with one surface of the anti-ferromagnetic layer,
one surface of the non-magnetic intermediate layer is adjacent to the other surface of the first ferromagnetic layer,
one surface of the second ferromagnetic layer is adjacent to the other surface of the non-magnetic intermediate layer,
one surface of the non-magnetic layer is adjacent to the other surface of the second ferromagnetic layer,
the free layer is an external magnetic field response layer and one surface thereof is adjacent to the other surface of the non-magnetic layer, and
the first ferromagnetic layer has a saturation magnetostriction which is not greater than (+3)×10⁻⁵ and an exchange coupling magnetic field Hex between itself and the anti-ferromagnetic layer which is not less than 48 (kA/m).

10. The magneto-resistive element according to claim 9, wherein a film thickness of the first ferromagnetic layer falls within a range of 1 to 2 (nm).

11. The magneto-resistive element according to claim 9, wherein the non-magnetic layer is an electroconductive layer.

12. The magneto-resistive element according to claim 9, wherein the non-magnetic layer is an insulating layer.

13. A thin film magnetic head comprising: a magneto-resistive element; and a slider,
wherein the magneto-resistive element is constituted of the magneto-resistive element according to claim 9, and
the slider supports the magneto-resistive element.

14. The thin film magnetic head according to claim 13, further comprising a writing element.

15. A magnetic head apparatus comprising: a thin film magnetic head; and a head support device,
wherein the thin film magnetic head is constituted of the thin film magnetic head according to claim 14, and
the head support device supports the thin film magnetic head.

16. A magnetic recording/reproducing apparatus comprising: a magnetic head apparatus; and a magnetic disk,
wherein the magnetic head apparatus is constituted of the magnetic head apparatus according to claim 15, and writes and reads a magnetic record on the magnetic disk.

17. A magneto-resistive element comprising: a first anti-ferromagnetic layer; a first ferromagnetic layer; a first non-magnetic intermediate layer; a second ferromagnetic layer; a first non-magnetic layer; a free layer; a second non-magnetic layer; a third ferromagnetic layer; a second non-magnetic intermediate layer; a fourth ferromagnetic layer; and a second anti-ferromagnetic layer,
wherein an upper surface of the first ferromagnetic layer is adjacently exchange-coupled with a lower surface of the first anti-ferromagnetic layer;
an upper surface of the first non-magnetic intermediate layer is adjacent to a lower surface of the first ferromagnetic layer,
an upper surface of the second ferromagnetic layer is adjacent to a lower surface of the first non-magnetic intermediate layer,
an upper surface of the first non-magnetic layer is adjacent to a lower surface of the second ferromagnetic layer,
the free layer is an external magnetic field response layer and an upper surface thereof is adjacent to a lower surface of the first non-magnetic layer,
an upper surface of the second non-magnetic layer is adjacent to a lower surface of the free layer,
an upper surface of the third ferromagnetic layer is adjacent to a lower surface of the second non-magnetic layer,
an upper surface of the second non-magnetic intermediate layer is adjacent to a lower surface of the third ferromagnetic layer,
an upper surface of the fourth ferromagnetic layer is adjacent to a lower surface of the second non-magnetic intermediate layer,
an upper surface of the second anti-ferromagnetic layer is adjacently exchange-coupled with a lower surface of the fourth ferromagnetic layer, and
the first ferromagnetic layer has a saturation magnetostriction which is not greater than (+3)×10⁻⁵ and an exchange coupling magnetic field Hex between itself and the first anti-ferromagnetic layer which is not less than 48 (kA/m).

18. The magneto-resistive element according to claim 17, wherein a film thickness of the first ferromagnetic layer falls within a range of 1 to 2 (nm).

19. The magneto-resistive element according to claim 17, wherein each of the first non-magnetic layer and the second non-magnetic layer is an electroconductive layer.

20. The magneto-resistive element according to claim 17, wherein each of the first non-magnetic layer and the second non-magnetic layer is an insulating layer.

21. A thin film magnetic head comprising: a magneto-resistive element; and a slider,
wherein the magneto-resistive element is constituted of the magneto-resistive element according to claim 17, and
the slider supports the magneto-resistive element.

22. The thin film magnetic head according to claim 21, further comprising a writing element.

23. A magnetic head apparatus comprising: a thin film magnetic head; and a head support device,
wherein the thin film magnetic head is constituted of the thin film magnetic head according to claim 22, and
the head support device supports the thin film magnetic head.

24. A magnetic recording/reproducing apparatus comprising: a magnetic head apparatus; and a magnetic disk,
wherein the magnetic head apparatus is constituted of the magnetic head apparatus according to claim 23, and writes and reads a magnetic record on the magnetic disk.

25. A magneto-resistive element comprising: an anti-ferromagnetic layer; a first ferromagnetic layer; a free layer; and a non-magnetic layer,
wherein the first ferromagnetic layer is adjacently exchange-coupled with the anti-ferromagnetic layer,
the free layer is an external magnetic field response layer,
the non-magnetic layer is positioned between the first ferromagnetic layer and the free layer, and
the first ferromagnetic layer consists of an alloy represented as CoₓFe_{y} and satisfies the following expression:
14.5 (at %)≦X≦35.1 (at %).

26. The magneto-resistive element according to claim 25, wherein the non-magnetic layer is an electroconductive layer.

27. The magneto-resistive element according to claim 25, wherein the non-magnetic layer is an insulating layer.

28. A thin film magnetic head comprising: a magneto-resistive element; and a slider,
wherein the magneto-resistive element is constituted of the magneto-resistive element according to claim 25, and
the slider supports the magneto-resistive element.

29. The thin film magnetic head according to claim 28, further comprising a writing element.

30. A magnetic head apparatus comprising: a thin film magnetic head; and a head support device,
wherein the thin film magnetic head is constituted of the thin film magnetic head according to claim 29, and
the head support device supports the thin film magnetic head.

31. A magnetic recording/reproducing apparatus comprising: a magnetic head apparatus; and a magnetic disk,
wherein the magnetic head apparatus is constituted of the magnetic head apparatus according to claim 30, and writes and reads a magnetic record on the magnetic disk.

32. A magneto-resistive element comprising: an anti-ferromagnetic layer; a first ferromagnetic layer; a non-magnetic intermediate layer; a second ferromagnetic layer; a non-magnetic layer; and a free layer,
wherein one surface of the first ferromagnetic layer is adjacently exchange-coupled with one surface of the anti-ferromagnetic layer,
one surface of the non-magnetic intermediate layer is adjacent to the other surface of the first ferromagnetic layer,
one surface of the second ferromagnetic layer is adjacent to the other surface of the non-magnetic intermediate layer,
one surface of the non-magnetic layer is adjacent to the other surface of the second ferromagnetic layer,
the free layer is an external magnetic field response layer and one surface thereof is adjacent to the other surface of the non-magnetic layer, and the first ferromagnetic layer consists of an alloy represented as CoₓFe_{y} and satisfies the following expression:
14.5 (at %)≦X≦35.1 (at %).

33. The magneto-resistive element according to claim 32, wherein the non-magnetic layer is an electroconductive layer.

34. The magneto-resistive element according to claim 32, wherein the non-magnetic layer is an insulating layer.

35. A thin film magnetic head comprising: a magneto-resistive element; and a slider,
wherein the magneto-resistive element is constituted of the magneto-resistive element according to claim 32, and
the slider supports the magneto-resistive element.

36. The thin film magnetic head according to claim 35, further comprising a writing element.

37. A magnetic head apparatus comprising: a thin film magnetic head; and a head support device,
wherein the thin film magnetic head is constituted of the thin film magnetic head according to claim 11, and
the head support device supports the thin film magnetic head.

38. A magnetic recording/reproducing apparatus comprising: a magnetic head apparatus; and a magnetic disk,
wherein the magnetic head apparatus is constituted of the magnetic head apparatus according to claim 37, and writes and reads a magnetic record on the magnetic disk.

39. A magneto-resistive element comprising: a first anti-ferromagnetic layer; a first ferromagnetic layer; a first non-magnetic intermediate layer; a second ferromagnetic layer; a first non-magnetic layer; a free layer; a second non-magnetic layer; a third ferromagnetic layer; a second non-magnetic intermediate layer; a fourth ferromagnetic layer; and a second anti-ferromagnetic layer,
wherein an upper surface of the first ferromagnetic layer is adjacently exchange-coupled with a lower surface of the first anti-ferromagnetic layer,
an upper surface of the first non-magnetic intermediate layer is adjacent to a lower surface of the first ferromagnetic layer,
an upper surface of the second ferromagnetic layer is adjacent to a lower surface of the first non-magnetic intermediate layer,
an upper surface of the first non-magnetic layer is adjacent to a lower surface of the second ferromagnetic layer,
the free layer is an external magnetic field response layer and an upper surface thereof is adjacent to a lower surface of the first non-magnetic layer,
an upper surface of the second non-magnetic layer is adjacent to a lower surface of the free layer,
an upper surface of the third ferromagnetic layer is adjacent to a lower surface of the second non-magnetic layer,
an upper surface of the second non-magnetic intermediate layer is adjacent to a lower surface of the third ferromagnetic layer,
an upper surface of the fourth ferromagnetic layer is adjacent to a lower surface of the second non-magnetic intermediate layer,
an upper surface of the second anti-ferromagnetic layer is adjacently exchange-coupled with a lower surface of the fourth ferromagnetic layer, and
the first ferromagnetic layer consists of an alloy represented as CoₓFe_{y} and satisfies the following expression:
14.5 (at %)≦X≦35.1 (at %).

40. The magneto-resistive element according to claim 39, wherein each of the first non-magnetic layer and the second non-magnetic layer is an electroconductive layer.

41. The magneto-resistive element according to claim 39, wherein each of the first non-magnetic layer and the second non-magnetic layer is an insulating layer.

42. A thin film magnetic head comprising: a magneto-resistive element; and a slider,
wherein the magneto-resistive element is constituted of the magneto-resistive element according to claim 39, and
the slider supports the magneto-resistive element.

43. The thin film magnetic head according to claim 42, further comprising a writing element.

44. A magnetic head apparatus comprising: a thin film magnetic head; and a head support device,
wherein the thin film magnetic head is constituted of the thin film magnetic head according to claim 43, and
the head support device supports the thin film magnetic head.

45. A magnetic recording/reproducing apparatus comprising: a magnetic head apparatus; and a magnetic disk,
wherein the magnetic head apparatus is constituted of the magnetic head apparatus according to claim 44, and writes and reads a magnetic record on the magnetic disk.
